(19) United States
(12) Patent Application Publication
(10) Pub. No.: US 2013/0143190 A1
(43) Pub. Date: Jun. 6, 2013

(54) HYDROGEN ATOM MODEL AS EDUCATIONAL TOOL

(71) Applicant: Haruo MATSUSHIMA, Yamatokooriyama-shi (JP)

(72) Inventor: Haruo MATSUSHIMA, Yamatokooriyama-shi (JP)

(21) Appl. No.: 13/531,720

(22) Filed: Jun. 25, 2012

(30) Foreign Application Priority Data
Dec. 1, 2011 (JP) 2011-277653

(51) Int. Cl. G09B 23/24

(52) U.S. Cl. 434/278

(57) ABSTRACT

A hydrogen atom model has a drawing or three-dimensional model which expresses an electric field in a form of electric lines of force and a magnetic field in a form of magnetic lines of force, as an example. The electric field is obtained by a gradient vector operation applied to a wave function of a hydrogen atom and a sign inversion to the result of the vector operation. The magnetic field obtained by multiplication of the wave function by a θ-directed unit vector in polar coordinates (r, θ, φ) and application of a rotational vector operation to the result of the multiplication.

### CROSS-REFERENCE STATEMENT

This application is based on Japanese patent application serial No. 2011-277653, filed with Japan Patent Office on Dec. 1, 2011. The content of the application is hereby incorporated by reference. The content of U.S. patent application Ser. No. 12/508,060 filed by the same applicant and published on Feb. 4, 2010 with publication No. US-2010-0028840-A1, the content of U.S. patent application Ser. No. 12/890,982 filed by the same applicant and published on Apr. 14, 2011 with publication No. US2011-0086333-A1, and the content of U.S. patent application Ser. No. 13/302,281 filed by the same applicant on Nov. 22, 2011, are also hereby incorporated by reference. Further, the content of Japanese patent application filed by the same applicant on Jun. 11, 2012 is hereby incorporated by reference.

### BACKGROUND

1. Technical Field

The present invention relates to a hydrogen atom model as an educational tool.

2. Related Art

It can be said that mathematical analyses are dominant in quantum mechanics, and therefore, educational tools that enable educands to have a concrete image for quantum mechanical systems are hardly found. FIGS. 5, 6A, 6B and 6C can only just be found as limited number of examples of the tools. FIG. 5 is a chart showing a well-known de Broglie's atom model. FIGS. 6A to 6C, which are copies of the upper most three charts shown as prior art in FIG. 10 of patent document 1 listed below, are charts showing existence probability distributions in 2pz, 2py and 2px orbitals, respectively. Patent documents 1 and 2 listed below, which the present applicant has filed, provide ones of scarce examples that have addressed an internal structure of a hydrogen atom, contrary to those in FIGS. 6A to 6C which provide a kind of classical image of a hydrogen atom. FIG. 7, which is FIG. 3 of patent document 1, is regarded as a view of electric lines of force 2 of a is orbirtal of a hydrogen atom. Patent document 2 describes an inconsistency in existence probability in an s orbital.

However, the idea that a wave function is a vector potential is only be a presumption, and not persuasive. In addition, electric lines of force 2 which come out of a proton having positive charge, go outward, and come back to the proton in accordance with the idea are inconsistent with physical law. Moreover, it does not seem natural that the distribution of an electric field anisotropic in terms of a z-axis is derived from a simple and spherically-symmetric wave function.

Prior art documents referred to in the present application are listed up here for convenience.
Patent document 1: US-2010-0028840-A1; and
Patent document 2: US-2011-0086333-A1.

### SUMMARY

One embodiment of the present invention is directed to a hydrogen atom model. The hydrogen atom model is a drawing or three-dimensional model which expresses an electric field. The electric field is obtained by a gradient vector operation applied to a wave function of a hydrogen atom and a sign inversion to the result of the vector operation.

### BRIEF DESCRIPTION OF DRAWINGS

FIG. 1 is a perspective view of a three-dimensional model expressing electric lines of force 2 and magnetic lines of force 3 in a 1s orbital of a hydrogen atom according to a first embodiment of the present invention;

FIG. 2 is a perspective view of a three-dimensional model expressing electric lines of force 2 and magnetic lines of force 3 in a 2s orbital of a hydrogen atom according to a first embodiment of the present invention;

FIG. 3 is a vertical cross-sectional view showing electric lines of force 2 in a 2pz orbital of a hydrogen atom according to the second embodiment of the present invention;

FIG. 4 is a vertical cross-sectional view showing electric lines of force 2 in a 2px orbital of a hydrogen atom according to the second embodiment of the present invention;

FIG. 5 is a planar view showing a standing wave orbital of an electron revolving around a proton as a wave according to conventional art;

FIGS. 6A to 6C are perspective views of three-dimensional models indicating existence probabilities in a 2p orbital of a hydrogen atom according to conventional art; and

FIG. 7 is a vertical cross-sectional view showing electric lines of force 2 in a 1s orbital of a hydrogen atom according to conventional art.

### DETAILED DESCRIPTION

In the following detailed description, for purposes of explanation, specific details are set forth in order to provide a thorough understanding of the disclosed embodiments. It will be apparent, however, that one or more embodiments may be practiced without these specific details. In other instances, well-known structures and devices are schematically shown in order to simplify the drawing.

An object of embodiments of the present invention is to solve the above-mentioned conventional problem, and to provide distribution of electric and magnetic fields in a hydrogen atom by reconsidering what a wave function of a hydrogen atom which is the origin of quantum mechanics is all about, to thereby enable an educand to have a concrete image or easily perform physical consideration concerning quantum mechanics which forms a basic of the sciences, and as a result, have an interest in the whole sciences.

As an outline, a hydrogen atom model as an educational tool according to the embodiments of the present invention is a drawing or three-dimensional model which expresses, as an electric field, a result of a gradient vector operation applied to a wave function and a sign inversion thereof. The embodiments, therefore, allow the inside of an atom having been incapable of being seen before to easily be seen, is useful for a phenomenon analysis, and allows an educand to have an interest in learning sciences.

Hereinafter, embodiments of the present invention will be described with reference to the accompanying drawings. Wave functions of a hydrogen atom having the first to fourth lowest energies are shown below. Each of the wave functions is expressed both in polar coordinates (r, θ, φ) and parabolic coordinates (ξ, η, φ) to be described later for the same position. Only the four wave functions are shown because the four functions are enough to outline the feature of the orbitals, and further because orbitals having higher energies are more complicated and not so suited to visualize the feature thereof. Vectors will hereinafter be expressed by bold and italic characters. A coefficient a₀ is Bohr radius. Normalization coefficients are omitted because the coefficients are not needed for calculation of electric and magnetic fields.

$$\begin{matrix}1 s orbital \text{:} \begin{matrix}exp ( - r / {a}_{0} ) = exp \{ - ( ξ + η ) / 2 {a}_{0} \} \\ = {u}_{000} ( ξ , η , φ )\end{matrix} & ( 1 ) \\ 2 s orbital \text{:} \begin{matrix}( 2 - r / {a}_{0} ) exp ( - r / 2 {a}_{0} ) = \{ 2 - ( ξ + η ) / 2 {a}_{0} \} exp \{ - ( ξ + η ) / 4 {a}_{0} \} \\ = {u}_{100} ( ξ , η , φ ) + {u}_{010} ( ξ , η , φ )\end{matrix} & ( 2 ) \\ 2 pz orbital \text{:} \begin{matrix}( r / {a}_{0} ) exp ( - r / 2 {a}_{0} ) cos θ = \{ ( η - ξ ) / 2 {a}_{0} \} exp \{ - ( ξ + η ) / 4 {a}_{0} \} \\ = {u}_{100} ( ξ , η , φ ) - {u}_{010} ( ξ , η , φ )\end{matrix} & ( 3 ) \\ reference \text{:} {u}_{100} ( ξ , η , φ ) = ( 1 - ξ / 2 {a}_{0} ) exp \{ - ( ξ + η ) / 4 {a}_{0} \} \\ {u}_{010} ( ξ , η , φ ) = ( 1 - η / 2 {a}_{0} ) exp \{ - ( ξ + η ) / 4 {a}_{0} \} & ( 4 ) \\ 2 px orbital \text{:} \begin{matrix}- r exp ( - r / 2 {a}_{0} ) sin θcos φ = - {( η ξ )}^{1 / 2} exp \{ - ( ξ + η ) / 4 {a}_{0} \} cos φ \\ ( = ) {u}_{001} ( ξ , η , φ )\end{matrix} & ( 5 )\end{matrix}$$

In formula 5, parentheses are added to an equality sign like “(=)” to show that the equality does not hold precisely.

An electric field is obtained by a gradient vector operation (expressed in formulas by “grad” or a well known inverted triangular symbol) applied to any of these wave functions and a sign inversion to the result of the vector operation. Electric lines of force 2 are obtained by continuously connecting one point with another along the direction of the electric field. 1s and 2s orbitals are expressed by a three-dimensional model. The model includes a sphere having a constant radius r of which part has been cut-off with planes having constant θ and φ. Electric lines of force 2 obtained by the above-mentioned operations and magnetic lines of force 3 to be described later are drawn in combination on the surfaces of the crippled sphere. These models for 1s and 2s orbitals are referred to as embodiment 1. 2pz and 2px orbitals are, because of some complexity thereof, expressed by drawings. Distribution of electric lines of force 2 on a vertical cross-sectional plane are shown on the drawings. These drawings for 2pz and 2px orbitals are referred to as embodiment 2.

### First Example

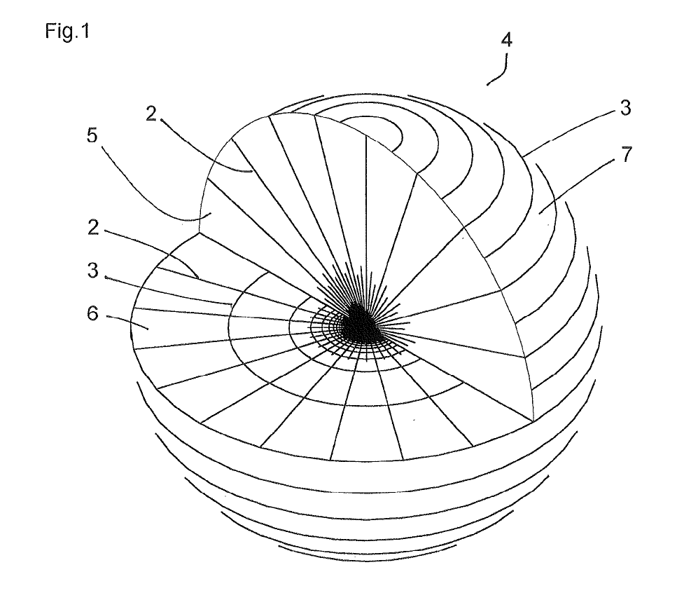

FIG. 1 illustrates a hydrogen atom model as an educational tool according to the first embodiment of the present invention. Electric field E obtained by a gradient vector operation applied to a wave function of a 1s orbital of a hydrogen atom represented by polar coordinates and shown in formula 1, and a sign inversion to the result of the vector operation is given by formula 6.

E=(1/a₀)exp(−r/a₀)iᵣ (6)

A vector iᵣis a unit vector in a direction of r.

Since the electric field only has an r-component, electric lines of force 2 are expressed by radial straight lines extending outward from the center of the orbital. Magnetic lines of force disclosed in patent document 1 are used for magnetic lines of force 3 as described later. Magnetic lines of force 3 are given by formula 7. In formula 7, difference between magnetic flux density and magnetic field, a coefficient μ₀, and the like are neglected, because those factors do not matter with magnetic lines of force 3.

H=(1/r−1/a₀)exp(−r/a₀)i_{φ} (7)

Here, a vector i_{φ} is a unit vector in a direction of φ. The atom model has a white-colored plastic sphere 4 having a radius of 6 cm as an example. A quarter of the sphere 4 has been cut off with a vertical plane 5 defined by φ=0 and φ=π and a horizontal plane 6 defined by θ=π/2. Components of electric lines of force 2 and magnetic lines of force 3 parallel to the surfaces of sphere 4, which include spherical surface 7, vertical plane 5 and horizontal plane 6, are drawn on the surfaces. Thus, three-dimensional relationship between the electric field and the magnetic field is shown in the atom model. Since electric lines of force 2 have components parallel to vertical plane 5, and both electric lines of force 2 and magnetic lines of force 3 have components parallel to horizontal plane 6, these parallel components are drawn on vertical plane 5 and horizontal plane 6. These parallel components are so drawn as to be dense around the center and to gradually become thinner with distance from the center to reflect dependence of the values given by formulas 6 and 7 on a radial coordinate r. Magnetic lines of force 3 have parallel components on spherical surface 7. The parallel components of magnetic lines of force 3 on spherical surface 7 are so drawn as to have a constant line-to-line distance to reflect no θ-dependence of the value given by formula 7. Electric lines of force 2 and magnetic lines of force 3 within a spherical region of which radius is 6 cm, which corresponds to r=6a₀, are shown in FIG. 1. Electric lines of force 2 can be drawn in red, and magnetic lines of force 3 in green, for example.

### Second Example

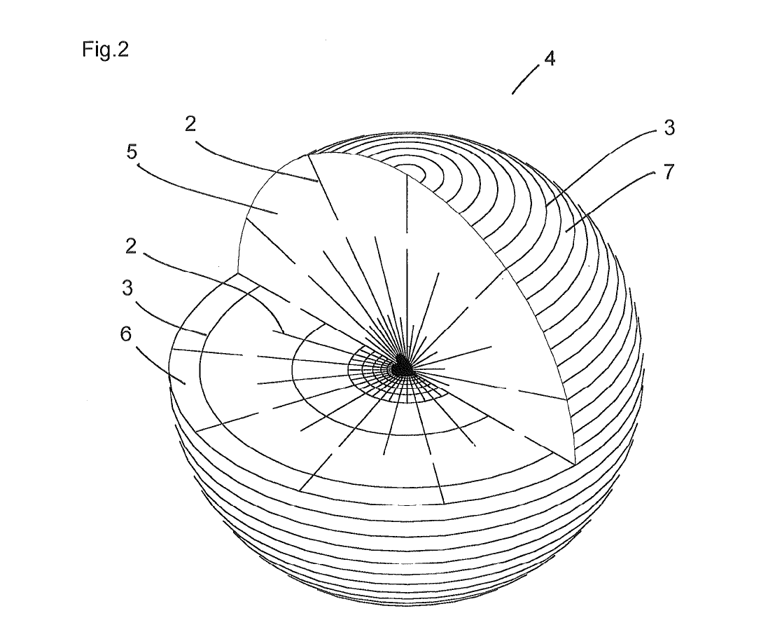

FIG. 2 illustrates a hydrogen atom model as an educational tool according to the first embodiment of the present invention, and expresses distribution of electric and magnetic fields in a 2s orbital of a hydrogen atom. The electric field shown in formula 8 is obtained by a gradient vector operation applied to a wave function of a 2s orbital represented by polar coordinates and shown in formula 2, and a sign inversion to the result of the vector operation.

E=(1/a₀)(2−r/2a₀)exp(−r/2a₀)iᵣ (8)

The magnetic field of the 2s orbital is given by formula 9.

H=(2/r−3/a₀+r/a₀²)exp(−r/2a₀)i_{φ} (9)

FIG. 2 is basically the same as FIG. 1. However, FIG. 2 is different from FIG. 1 in having no electric lines of force 2 drawn, in red for example, in a region of which radius is around r=4a₀ either on the vertical plane 5 or horizontal plane 6, because the electric field in a 2s orbital is zero at the radius r=4a₀.

### Third Example

FIG. 3 illustrates a hydrogen atom model as an educational tool according to the second embodiment of the present invention, and expresses electric lines of force 2 of a 2pz orbital drawn on a vertical plane defined by any constant azimuthal angle φ. Electric field E obtained by a gradient vector operation applied to the wave function u₁₀₀ represented by parabolic coordinates and shown in formula 4, and a sign inversion to the result of the vector operation is given by formula 10.

E={i_{ξ}(3−ξ/2a₀)ξ^{1/2}+i_{η}(1−ξ/2a₀)η^{1/2}}exp{−(ξ+η)/4a₀}/{2a₀(ξ+η)^{1/2}} (10)

Here, vectors i_{ξ} and i_{η} are unit vectors in directions of ξ and η, respectively. A plurality of electric lines of force 2 within a circular region having a radius of r=6a₀ drawn in FIG. 3 are obtained by applying the method disclosed in patent document 2 to formula 10.

### Fourth Example

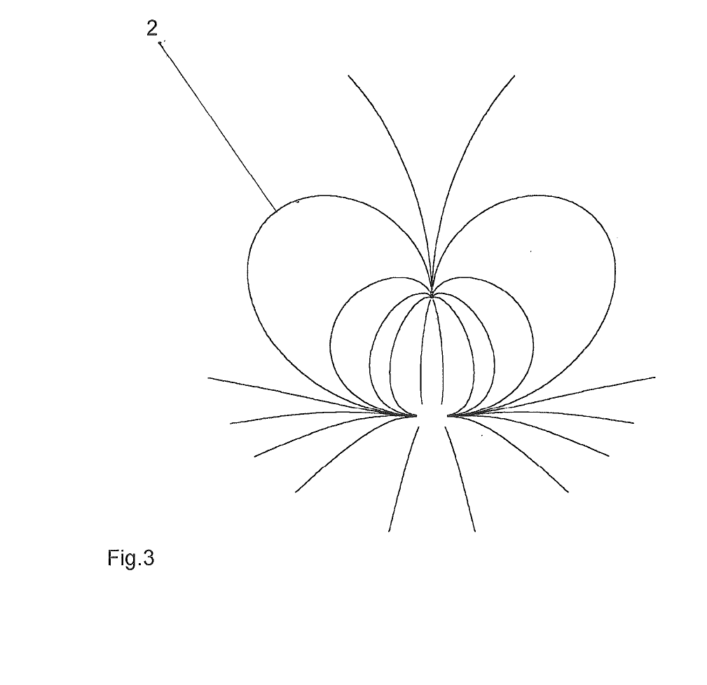

FIG. 4 illustrates a hydrogen atom model (drawing) as an educational tool according to the second embodiment of the present invention. Electric field E obtained by a gradient vector operation applied to a wave function of a 2px orbital represented by polar coordinates and shown in formula 5, and a sign inversion to the result of the vector operation is given by formula 11.

E=exp(−r/2a₀){iᵣ(1−r/2a₀)sin θ cos φ+i_{θ} cos θ cos φ−i_{φ} sin φ} (11)

Since electric field E given by formula 11 is complicated and the feature thereof cannot easily be viewed, planes defined by azimuthal angles φ=0 and φ=π where a φ-component of electric field E is zero is selected for a vertical cross-sectional plane on which electric lines of force 2 are drawn. FIG. 4 is based on an idea that a polar angle θ is in the range of π<θ<2π on a plane defined by φ=π. Electric lines of force 2 within a circular region having a radius of r=6a₀ are drawn in FIG. 4 similarly to FIGS. 1 to 3. Electric lines of force 2 are obtained by the same method used for FIG. 3.

Prior to explanation on action and function of educational tools having above-described configurations, it is explained what a solution of Shrodinger equation, i.e. a wave function is. A wave function is an electric potential (electrostatic potential). The bases of this theory are given by following (1) to (4) and others. (1) An electric potential, since being a scalar quantity having the dimension of work, is suitable for a solution of Shrodinger equation which treats work (energy). (2) The theory well explains the reason why a wave function has positive and negative values. (3) The theory is compatible with a basic image of an atom where equivalent electric charge of an electron is dispersed and distributed around a proton. (4) The theory, since being identical in essential part with the current existence-probability theory, has little inconsistency with a variety of existing experimental results.

Supplemental explanation is briefly given to reason (3). Based on basics of electro-dynamics, an electric potential φ at an observation point distant from a unit charge q by a distance r is defined by formula 12.

φ=(1/4πε₀)q/|r| (12)

Since electric potentials are superimposable, a total electric potential φₙ resulting from n electric charges is defined by formula 13.

$${φ}_{n} = ( 1 / 4 π {ɛ}_{0} ) {\sum }_{i = 1}^{n} {q}_{i} / \vert {r}_{i} \vert \qquad ( 13 )$$

Application of this idea to a hydrogen atom where negative electric charge of an electron is supposed to be dispersed and distributed in equivalent around a proton having positive charge allows an electric potential as a function of an observation point to be defined by superposition of contributions from all the positive and negative electric charges. The theory regards this electric potential as a wave function. Regarding reason (4), the existence probability theory focuses on a frequency of an electron to pass through any point, whereas the distribution of equivalently dispersed electric charge focuses on an amount of electric charges. The two quantities are supposed to be proportional to each other.

Once a wave function of a hydrogen atom is supposed to be an electric potential, an electric field can be obtained by a gradient vector operation applied to the wave function and a sign inversion to the result of the vector operation. As shown in formulas 6 and 8, the obtained electric fields are very simple: the electric fields in 1s and 2s orbitals face in a radial direction, and spherically symmetric similarly to the wave function itself. Thus, the afore-mentioned problems to be solved are all solved.

A gradient vector operation applied to the wave function shown in formula 3 which expresses a 2pz orbital and is represented by polar coordinates brings formula 14.

E=exp(−r/2a₀){iᵣ(r/2a₀−1)cos θ+i_{θ} sin θ}/a₀ (14)

Replacement of cos θ with −cos θ under 0<θ<π/2 will bring a drawing (not shown) which corresponds to a 90-degree clockwise rotation of FIG. 4. FIG. 4 will be referred to later. The reason thereof is that FIG. 4 is drawn from a formula which corresponds to a substitution of cos φ=1 and sin φ=0 for the above-stated formula 11, and in other words, corresponds to formula 14 with cos θ and sin θ replaced with each other. However, since there may arise an assertion that the replacement of cos θ with −cos θ should be done before the gradient vector operation, a counter argument is shown here beforehand. First, a gradient vector operation applied to u₁₀₀ represented by parabolic coordinates and shown in formula 4 as reference leads to formula 10. FIG. 3, which expresses an electric field given by formula 10, is identical with a drawing obtained by a 90-degree rotation of FIG. 4 from the view point of a basically heart-like form commonly shared thereby in spite of minor difference left in detail. Second, the gradient vector operation applied to formula 3 after the replacement of cos θ with −cos θ leads to formula 15.

E=exp(−r/2a₀){iᵣ(1−r/2a₀)cos θ−i_{θ} sin θ}/a₀ (15)

It will easily be understood that a replacement of cos θ with −cos θ under π/2<θ<π in formula 15 leads to a drawing which is upside-down in one given by formula 14. Further, u₀₁₀ in formula 4 gives a drawing which is upside-down in FIG. 3. Thus, a relation between u₀₁₀ and formula 15 is perfectly identical with a relation between u₁₀₀ and formula 14.

In other words, u₁₀₀ and u₀₁₀ represented by parabolic coordinates in formula 4 and wave functions having positive and negative signs for cos θ and represented by polar coordinates in formula 3 are all directly derived from Shrodinger equation, and a gradient vector operation applied to these functions bring results similar to each other. Therefore, it looks as if Shrodinger equation itself strongly suggests that a wave function=an electric potential. However, only a simple sight of the forms of the functions must have resulted in a wrong interpretation since a subtraction of u₀₁₀ from u₁₀₀ brings a wave function of a 2pz orbital represented by polar coordinates as shown in formula 3. It should be noted that a representation by parabolic coordinates is adopted for the drawing of electric lines of force in a 2pz orbital shown in FIG. 3 instead of a representation by polar coordinates which may cause a question.

Further explanation is provided just for reference. Some on-sale textbooks present an introduction to the fact that a wave function of a hydrogen atom can be derived even based on parabolic coordinates (ξ, η, φ). According to the textbooks, parabolic coordinates (ξ, η, φ) are defined by formula 16 with orthogonal coordinates (x, y, z) and polar coordinates (r, θ, φ). Wave functions are expressed like u₁₀₀ with three quantum numbers n₁, n₂, and m attached in this order as a suffix.

x=(ξη)^{1/2} cos φ, y=(ξη)^{1/2} sin φ, z=(η−ξ)/2ξ=r(1−cos θ)=r−z, η=r(1+cos θ)=r+z, φ=φ (16)

The reasons why formula 5 expressing a 2px orbital has a negative sign are that: (1) a wave function itself can either be positive or negative, (2) the wave function having a negative sign brings an electric field compatible with physical law, and others. The reasons why a polar angle θ is given a value between 0 and n for a plane having an azimuthal angle φ=0, and between π and 2π for φ=π are that: (1) an electric field compatible with physical law is obtained, and (2) if a polar angle θ is given a value between 0 and π even for a plane having an azimuthal angle φ=π, sin θ will be discontinuous and indifferentiable on a border between the first and fourth quadrants where θ is zero, and others.

For explanation on a magnetic field, a conventional image of a hydrogen atom expressed as an electron having negative electric charge exists as a standing wave around a proton having positive electric charge located at the center is considered. There are two cases that result in a standing wave: first, two waves traveling in counter directions form a standing wave, and second, as shown in FIG. 5, a traveling wave on a circle catching up itself from one or more turns behind forms a standing wave. In any case, a standing wave appears based on the existence of a traveling wave. Electric charge which, even as a wave, is moving causes an electric current. One moment figure of the current is nothing but a standing wave, and an electric potential (electrostatic potential) formed by the standing wave is nothing but a wave function. The present invention is based on this idea.

This idea will hereinafter be expressed by formulas. If each electric charge q, in formula 13 which provides an electric potential is supposed to move at the same vector velocity v, and the coefficient is replaced properly, then formula 13 will provide a vector potential Aₙ instead as shown in formula 17.

$$\begin{matrix}{A}_{n} = ( {μ}_{o} / 4 π ) {\sum }_{i = 1}^{n} {q}_{i} v / \vert {r}_{i} \vert \\ = ( {μ}_{o} / 4 π ) \{ {\sum }_{i = 1}^{n} {q}_{i} / \vert {r}_{i} \vert \} v \\ = ( {μ}_{o} {ɛ}_{0} ) {φ}_{n} v\end{matrix} \qquad ( 17 )$$

Formula 17 also shows the relation of the vector potential Aₙ with the electric potential φₙ shown in formula 13. This relation is derived by an operation that moves the velocity v out of the summation symbol Σ. Although the direction of the velocity v may be the direction of an electron orbital, the feature of the electron orbital itself is unknown. However, as far as s orbitals are concerned, statistically averaged orbitals may be regarded as circles having a proton at the center thereof. Therefore, the direction of the electric current is most properly the direction of the great circle, i.e., the θ-direction. Formula 17 will be modified into formula 18 by replacing the vector velocity v with vi_{θ}.

Aₙ=(μₒξ₀)vφₙi_{θ} (18)

A magnetic flux density is obtained by applying a rotational operation to the vector potential given by formula 18. A magnetic field is obtained by dividing the magnetic flux density by μₒ. Thus, the theory of “wave function=vector potential” provided by patent document 1 is given a basis thereof.

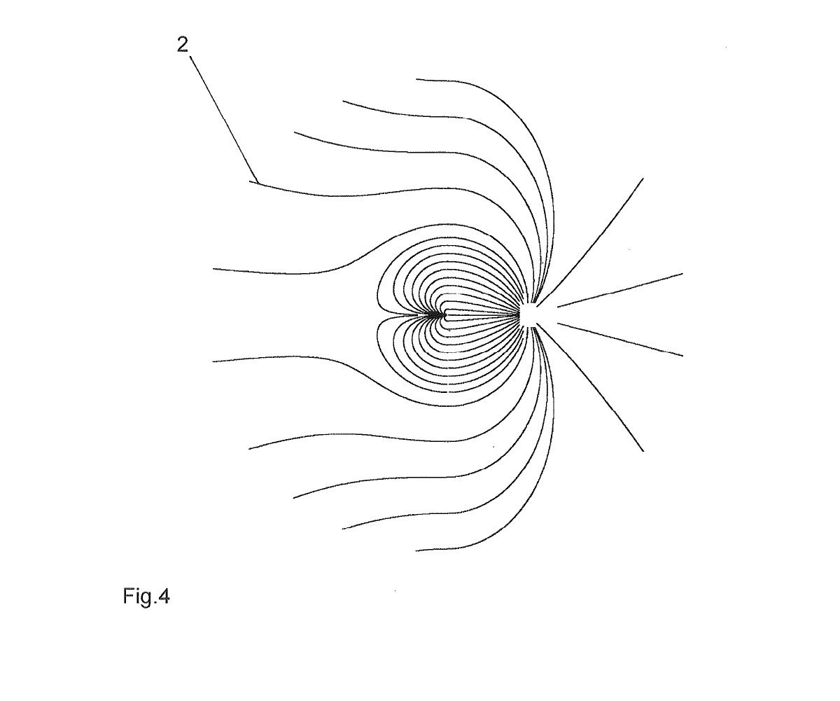

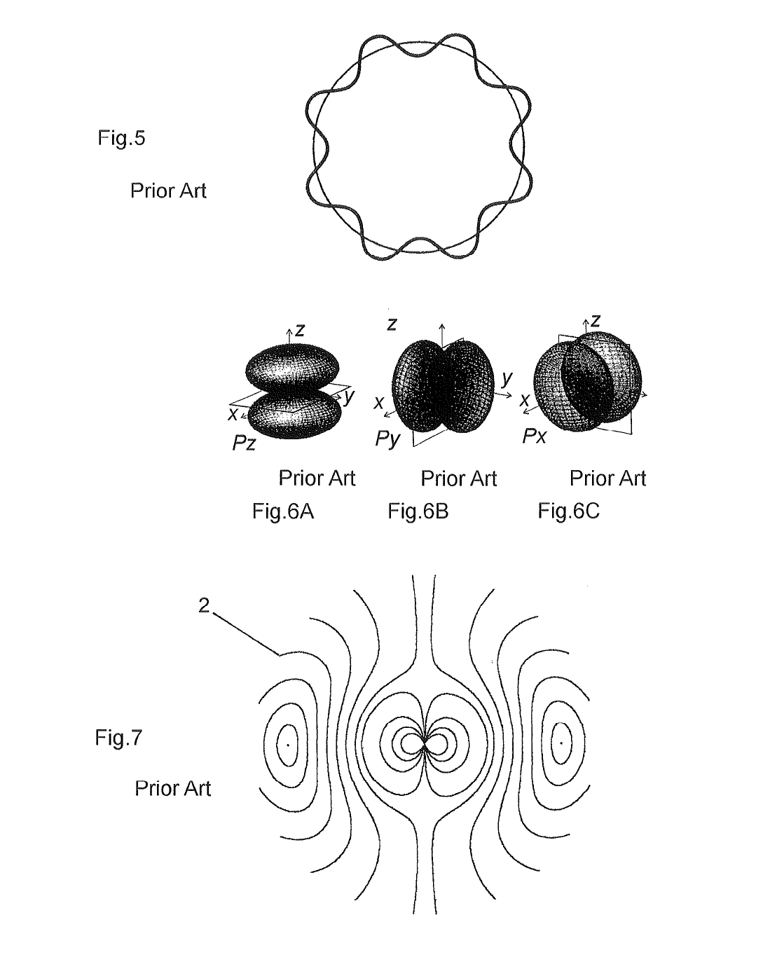

However, since a θ-direction is a southward direction in a hydrogen atom compared to Earth, components along east-westward directions and a vertical direction are all excluded as a result. Components along east-westward directions cannot be excluded even for s orbitals. Further, in other orbitals, since an electron is thought to revolve along the orbitals each of which is like a set of ellipsoidal bodies placed in spherical symmetry with each other as derived from analogy with FIGS. 6A, 6B and 6C, the vertical component should be considered. Anyway, components along other directions than a θ-direction, especially an r-component which is inevitable for an orbital having ellipsoidal bodies, have to be taken into account. However, a rotational operation applied to an r-directed vector potential unfortunately results in zero.

Therefore, parabolic coordinates are considered again. Multiplying a wave function u₀₀₀(ξ, η, φ) of a 1s orbital by a unit vector of a ξ-direction, applying a rotational operation to the result of the multiplication, and regarding the result of the rotational operation as a magnetic field H, will bring formula 19.

$$\begin{matrix}H = rot {u}_{000} ( ξ , η , φ ) \\ = rot exp \{ - ( ξ + η ) / 2 {a}_{0} \} {i}_{ξ} \\ = exp \{ - ( ξ + η ) / 2 {a}_{0} \} {\{ η / ( ξ + η ) \}}^{1 / 2} \{ ( 1 / {a}_{0} - 1 / ( ξ + η ) \} {i}_{φ} \\ = exp ( - r / {a}_{0} ) {\{ 2 ( 1 + cos θ ) \}}^{1 / 2} ( 1 / {a}_{0} - 2 / r ) {i}_{φ}\end{matrix} \qquad ( 19 )$$

Although depending on a polar coordinate θ contrary to that given by formula 7, the magnetic field given by formula 19 depends on a radial coordinate r in a manner similar to that given by formula 7. Among others, the magnetic field given by formula 19 is the same as that given by formula 7 in being a vector that only has a φ-component. Since a magnetic field only having a component has been obtained also from a ξ-directed electric current which includes an r-component to a certain extent, a magnetic field in a 1s orbital of a hydrogen atom can be regarded as only having a φ-component. Thus, a simple wave function represented by polar coordinates has been utilized.

Results of the embodiments of the present invention will hereinafter be described. The embodiments of the present invention, in a manner, visualize the inside of a hydrogen atom, and thereby, allow educands to understand how a difference in a wave function causes a difference in the internal structure. For example, it is easily seen that in a 1s orbital, both of electric and magnetic fields are concentrated in the vicinity of the center of the orbital, a 2s orbital extends out of a 1s orbital, and an electric field in a 2s orbital is zero at a radius r=2a₀. Further, distribution of equivalently dispersed negative electric charge, which is not addressed in patent document 1, can be imagined. According to basics of electromagnetics, electric lines of force 2 are the segments that come out of positive electric charge, connect one point to another along an electric field, and sink into negative electric charge. Therefore, FIG. 3 and formula 10, for example, allow presumption that negative electric charge in a 2pz orbital is concentrated around a point where ξ=6a₀, η=0 in parabolic coordinates, or r=3a₀, θ=π in polar coordinates. FIG. 2 and formula 8 allow presumption that negative electric charge in a 2s orbital is concentrated near a spherical surface where a radius r=4a₀. FIG. 1 and formula 6 allow presumption that negative electric charge in a 1s orbital is concentrated in the vicinity of a proton. FIG. 4 and formula 11 allow presumption that negative electric charge in a 2px orbital is concentrated around a point where φ=0, θ=π/2, and r=2a₀.

Further, formulas of electric fields obtained according to the embodiments of the present invention allow energy of electric fields not calculated in patent document 1 to be calculated. A whole-space integration of square of a formula (including a normalization coefficient) that gives an electric field in an ns orbital leads to energy of 1/(a₀²n²). This energy is proportional to Bohr's energy levels, and at the same time, identical with energy of a magnetic field calculated in patent document 1. This result backs up lossless-resonator theory shown in patent document 1 and will be an indirect evidence for the theory of “wave function=electric potential.”

As described above, the embodiments of the present invention advantageously raises educands' interest in sciences, and especially quantum mechanics, with the drawings or the three-dimensional models expressing the internal structure of an atom which has not been seen and helps to prevent them from going away from sciences, and furthermore, prevent their misunderstanding that can be caused by inference only weighted in mathematics. In addition, the embodiments of the present invention enable calculation of energy levels of a hydrogen atom and are expected to contribute to education for quantum mechanics.

### INDUSTRIAL APPLICABILITY

As described above, a hydrogen atom model as an educational tool in accordance with the embodiments of the present invention visualizes the figure of a hydrogen atom, enables educands to have a close feeling toward hardly understood or approached quantum mechanics, prevents them from going away from sciences, and is therefore useful for education and research.

What is claimed is:

1. A hydrogen atom model as an educational tool, comprising one of a drawing and a three-dimensional model expressing an electric field obtained by a gradient vector operation applied to a wave function of a hydrogen atom and a sign inversion to a result of the vector operation.

2. The hydrogen atom model according to claim 1, wherein the wave function of a hydrogen atom is a wave function of any one of 1s, 2s, 2px, 2py and 2pz orbitals.

3. The hydrogen atom model according to claim 1, wherein the electric field is expressed in a form of electric lines of force.

4. The hydrogen atom model according to claim 3, wherein the one of a drawing and a three-dimensional model is the drawing, and the drawing expresses the electric lines of force in a 2pz orbital of a hydrogen atom on a plane where an azimuthal angle φ in polar coordinates (r, θ, φ) is constant.

5. The hydrogen atom model according to claim 3, wherein the one of a drawing and a three-dimensional model is the drawing, and the drawing expresses the electric lines of force in a 2px orbital of a hydrogen atom on a plane where an azimuthal angle φ in polar coordinates (r, θ, φ) is 0 or 180 degrees.

6. The hydrogen atom model according to claim 1, wherein the wave function is represented by polar coordinates (r, θ, φ), and the one of a drawing and a three-dimensional model further expresses a magnetic field obtained by multiplication of the wave function by a θ-directed unit vector and application of a rotational vector operation to a result of the multiplication.

7. The hydrogen atom model according to claim 6, wherein the magnetic field is expressed in a form of magnetic lines of force.

8. The hydrogen atom model according to claim 6, wherein the one of a drawing and a three-dimensional model is the three-dimensional model, the three-dimensional model includes a sphere of which part has been cut-off, and both components of the electric field and the magnetic field parallel to surfaces of the sphere are drawn on the surfaces.

9. The hydrogen atom model according to claim 8, wherein a quarter of the sphere has been cut off with a vertical plane defined by φ=0 and φ=180 degrees and a horizontal plane defined by θ=90 degrees in the polar coordinates.

10. The hydrogen atom model according to claim 1, wherein the wave function is represented by parabolic coordinates (ξ, η, φ).

11. The hydrogen atom model according to claim 10, wherein the one of a drawing and a three-dimensional model further expresses a magnetic field obtained by multiplication of the wave function by a ξ-directed or η-directed unit vector and applying a rotational vector operation to a result of the multiplication.

12. The hydrogen atom model according to claim 11, wherein the magnetic field is expressed in a form of magnetic lines of force.

13. The hydrogen atom model according to claim 12, wherein the one of a drawing and a three-dimensional model is the three-dimensional model, the three-dimensional model includes a sphere of which part has been cut-off, and both components of the electric field and the magnetic field parallel to surfaces of the sphere are drawn on the surfaces.

14. The hydrogen atom model according to claim 13, wherein a quarter of the sphere has been cut off with a vertical plane defined by φ=0 and φ=180 degrees and a horizontal plane defined by θ=90 degrees in polar coordinates (r, θ, φ).
